(19) United States
(12) Patent Application Publication
(10) Pub. No.: US 2025/0260016 A1
(43) Pub. Date: Aug. 14, 2025

(54) ALL SOLID-STATE-BATTERY INCLUDING ANODE HAVING SUPPRESSED VOLUME EXPANSION IN VERTICAL AND HORIZONTAL DIRECTIONS AND MANUFACTURING METHOD THEREOF

(71) Applicants: Hyundai Motor Company, Seoul (KR); Kia Corporation, Seoul (KR)

(72) Inventors: Hee Soo Kang, Seoul (KR); Hong Suk Choi, Seoul (KR); Seon Hwa Kim, Seoul (KR); Dong Hyun Cho, Seoul (KR); Jae Seok Nam, Seoul (KR); Jae Min Lim, Seoul (KR); So Yeon Kim, Seoul (KR)

(21) Appl. No.: 18/797,887

(22) Filed: Aug. 8, 2024

(30) Foreign Application Priority Data
Feb. 8, 2024 (KR) 10-2024-0019534

(51) Int. Cl. H01M 4/62; H01M 4/02; H01M 4/36

(52) U.S. Cl. CPC H01M 4/628; H01M 4/366; H01M 4/625; H01M 2004/021; H01M 2004/027; H01M 2220/20

(57) ABSTRACT

An all-solid-state battery including an anode with suppressed volume expansion in the vertical and horizontal directions and a manufacturing method thereof, wherein a buffer layer to suppress volume expansion of the anode in the vertical and horizontal directions is inserted between an anode current collector and a solid electrolyte layer. This configuration prevents deterioration of cell characteristics caused by volume changes during charging and discharging, thereby improving the efficiency, durability and resistance characteristics of the all-solid-state battery.

### CROSS-REFERENCE TO RELATED APPLICATION

This application claims under 35 U.S.C. § 119 (a) the benefit of Korean Patent Application No. 10-2024-0019534 filed on Feb. 8, 2024, the entire contents of which are incorporated herein by reference.

### (a) TECHNICAL FIELD

The present disclosure relates to an all-solid-state battery, including an anode having suppressed volume expansion in the vertical and horizontal directions, and a manufacturing method thereof. A buffer layer to suppress volume expansion of the anode in the vertical and horizontal directions may be inserted between an anode current collector and a solid electrolyte layer. This arrangement prevents deterioration of cell characteristics caused by volume changes during charging and discharging of the all-solid-state battery, thereby improving efficiency, durability and resistance characteristics of the all-solid-state battery.

### (b) BACKGROUND

All-solid-state batteries, which are attracting attention as next-generation secondary batteries, include a laminate in which an anode current collector, an anode layer, a solid electrolyte layer including a solid electrolyte, a cathode layer, and a cathode current collector are stacked in order.

In general, all-solid-state batteries use an anode layer in the form of a composite of an active material (graphite) and a solid electrolyte so as to ensure ionic conductivity in the anode layer. However, due to the addition of the solid electrolyte to the anode layer, the ratio of the anode active material is lowered. Consequently, the energy density of all-solid-state batteries may be reduced compared to lithium-ion batteries that use an electrolyte solution.

In order to improve the energy density of these all-solid-state batteries, recent research has focused on applying metallic lithium is also being conducted recently. However, there are many obstacles to overcome for commercialization, ranging from research technical issues, such as interfacial bonding and dendrite growth, to industrial technical issues, such as cost and scalability.

Recently, research on lithium storage-type anodeless batteries, in which an anode is omitted and lithium (Li) is directly deposited on an anode current collector, is also being conducted.

Specifically, it has been reported that Li may be deposited (stored) using an anode layer formed of an Ag—C composite. In such an Ag—C composite layer-based anode, during charging, Li from a cathode layer is moved to the anode layer and is deposited (stored) between an Ag—C composite layer and an anode current collector causing the anode's volume to expand. During discharging, the stored Li is returned to the cathode layer, causing the anode's volume to contract. However, as the charging and discharging process is repeated, the volume expansion and contraction of each electrode is repeated, and a difference in pressure applied to each electrode and the composite layer occurs. Accordingly, an interface contact defect between each electrode and the composite layer occurs, cell resistance increases, or Li is non-uniformly deposited, thereby causing deterioration in cell performance.

In order to reduce the volume expansion or contraction of each electrode during charging and discharging, a thick pad configured to compensate for the volume expansion during operation of cells is sometimes used, but when implementing stacked cells, it is difficult to compensate for the volume expansion of each cell.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to prevent deterioration of electrochemical characteristics by minimizing changes in volume of an anode layer during the charging and discharging process of an all-solid-state battery.

Particularly, due to the characteristics of the all-solid-state battery operated under a designated pressure, lithium may be deposited at the edge of the anode layer when the battery is charged. When the battery continues to be charged and discharged in the state in which lithium is deposited at the edge of the anode layer, voltage may be concentrated on the edge, deposition of lithium may be accelerated, and deterioration of the electrochemical characteristics of the battery may be intensified. Accordingly, in one aspect, the present disclosure intends to provide an all-solid-state battery which may control not only volume expansion of an anode layer in the vertical direction but also volume expansion of the anode layer in the horizontal direction.

The objects of the present disclosure are not limited to the above-mentioned objects. The objects of the present disclosure will become clearer from the following description, and may be realized by means stated in the claims and combinations thereof.

In one aspect, the present disclosure provides an all-solid-state battery including an anode current collector, a buffer layer located on the anode current collector, a solid electrolyte layer including a solid electrolyte and located on the buffer layer, a cathode active material layer including a cathode active material and located on the solid electrolyte layer, and a cathode current collector located on the cathode active material layer, wherein the buffer layer includes a carbon sheet including an oriented carbon material aligned to form a predetermined angle with the anode current collector.

In aspects, preferably, lithiophilic metal material (e.g. lithiophilic metal particles) are associated with (e.g. attached to or incorporated into) the oriented carbon material.

In a preferred embodiment, the oriented carbon material may include vertically aligned carbon nanotubes (VA-CNTs).

In another preferred embodiment, a length of the oriented carbon material may be about 4 to about 60 μm.

In still another preferred embodiment, the predetermined angle may be 60° to 90°.

In yet another preferred embodiment, the lithiophilic metal material (e.g. lithiophilic metal particles) may include one selected from the group consisting of silver (Ag), gold (Au), magnesium (Mg), aluminum (Al), indium (In), silicon (Si), manganese (Mn), tin (Sn), bismuth (Bi), zinc (Zn), germanium (Ge), platinum (Pt), antimony (Sb), and combinations thereof.

In still yet another preferred embodiment, a thickness of the buffer layer may be about 4 to about 50 μm.

In a further preferred embodiment, the buffer layer may have a porous structure; and porosity of the buffer layer may be about 50% or more.

In another further preferred embodiment, a weight ratio of the lithiophilic metal particles to the carbon sheet of the buffer layer may be about 1:5 to about 1:15.

In still another further preferred embodiment, when the all-solid-state battery is in a fully charged state (SoC of 100), a thickness of a lithium layer including lithium deposited in the buffer layer may be equal to or less than a thickness of the buffer layer.

In yet another further preferred embodiment, a thickness of the buffer layer when the all-solid-state battery is in a fully charged state (SoC of 100) and a thickness of the buffer layer when the all-solid-state battery is in a fully discharged state (SoC of 0) may be the same or substantially the same.

In still yet another further preferred embodiment, in aspects, the lithiophilic metal materials do not form a separate layer. For example, in such aspects the lithiophilic metal materials (e.g. lithiophilic metal particles) may be incorporated into the carbon material.

In another aspect, the present disclosure provides a manufacturing method of an all-solid-state battery including immersing a carbon sheet including an oriented carbon material into a solution including a salt of lithiophilic metal material (e.g. lithiophilic metal particles) and a reducing agent, stirring the solution with the carbon sheet to the lithiophilic metal material to a surface of the oriented carbon material, thereby forming a buffer layer, and stacking an anode current collector, the buffer layer, a solid electrolyte layer including a solid electrolyte, a cathode active material layer including a cathode active material, and a cathode current collector.

In a preferred embodiment, stirring the solution may be performed at a temperature of about 70° C. to about 90° C.

In another preferred embodiment, the reducing agent may include trisodium citrate.

In still another preferred embodiment, the oriented carbon material may include vertically aligned carbon nanotubes (VA-CNTs).

In yet another preferred embodiment, a length of the oriented carbon material may be about 4 to about 60 μm.

In still yet another preferred embodiment, an angle formed by the oriented carbon material and the anode current collector may be about 60° to about 90°.

In a further preferred embodiment, the lithiophilic metal materials (e.g. lithiophilic metal particles) may include one selected from the group consisting of silver (Ag), gold (Au), magnesium (Mg), aluminum (Al), indium (In), silicon (Si), manganese (Mn), tin (Sn), bismuth (Bi), zinc (Zn), germanium (Ge), platinum (Pt), antimony (Sb), and combinations thereof.

In another further preferred embodiment, a thickness of the buffer layer may be about 4 to about 50 μm.

In still another further preferred embodiment, the buffer layer may have a porous structure, and porosity of the buffer layer may be about 50% or more.

In yet another further preferred embodiment, a weight ratio of the lithiophilic metal particles to the carbon sheet of the buffer layer may be about 1:5 to about 1:15.

In still yet another further preferred embodiment, when the all-solid-state battery is in a fully charged state (SoC of 100), a thickness of a lithium layer including lithium deposited in the buffer layer may be equal to or less than a thickness of the buffer layer.

In a still further preferred embodiment, a thickness of the buffer layer when the all-solid-state battery is in a fully charged state (SoC of 100) and a thickness of the buffer layer when the all-solid-state battery is in a fully discharged state (SoC of 0) may be the same or substantially the same.

In a yet still further preferred embodiment, the lithiophilic metal materials (e.g. lithiophilic metal particles) may do not form a separate layer.

In further aspects, vehicles are provided that comprises a battery as disclosed herein, including an all-solid-state battery as disclosed herein.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a cross-sectional view showing an all-solid-state battery including a buffer layer according to the present disclosure;

FIG. 2 shows the discharged state of the buffer layer according to the present disclosure;

FIG. 3 shows the charged state of the buffer layer according to the present disclosure;

FIG. 4 shows a buffer layer according to another embodiment of the present disclosure;

FIG. 5 is a graph showing voltage profiles of all-solid-state batteries according to Example and Comparative Examples while initially charging the discharging the all-solid-state batteries; and

FIG. 6 is a graph showing durability analysis results of the all-solid-state batteries according to Example and Comparative Examples.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the accompanying drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

As used herein, the term “substantially the same” refers to a difference between two values not exceeding 10% of a base value (e.g., one of the two values). e.g., not exceeding 8%, not exceeding 6%, not exceeding 4%, not exceeding 2%, not exceeding 1%, not exceeding 0.5%, not exceeding 0.1%, not exceeding 0.05%, and not exceeding 0.01%, of the base value.

### All-Solid-State Battery

In a conventional all-solid-state battery which uses a composite layer including Ag—C as an anode layer, volume expansion and contraction of the composite layer is repeated as charging and discharging of the all-solid-state battery progresses. As lithium deposited is ionized and moves to a cathode layer during the discharging process of the conventional all-solid-state battery, pressure in the composite layer decreases, and in this process, a contact defect occurs at the interface between the composite layer and a solid electrolyte layer or between the composite layer and an anode current collector.

To address this problem, a technology has been disclosed that involves inserting a carbon nanotube (CNT) sheet between the composite layer and the anode current collector to accommodate volume expansion of the anode layer or the composite layer.

However, the conventional technology in which the carbon nanotube sheet is interposed between the anode current collector and the composite layer may accommodate the volume expansion of the anode current collector in the vertical direction to some extent, but may not accommodate the volume expansion in the horizontal direction. Specifically, when the conventional all-solid-state battery including the anode layer including the composite layer and the carbon nanotube sheet is charged, lithium ions migrated from a cathode layer are deposited between and inside the composite layer and the carbon nanotube sheet. At this time, since the carbon nanotube sheet may not suppress volume expansion in the horizontal direction, lithium may be irreversibly deposited up to the edge of the anode layer. As a result, lithium ions may be lost, the overall structure of the all-solid-state battery may collapse, and the battery's durability may decrease. When charging and discharging is continued in this state, lithium dendrites may grow at the interface between the respective layers and may reduce durability of the battery, or in severe cases, may cause internal short circuit of the battery.

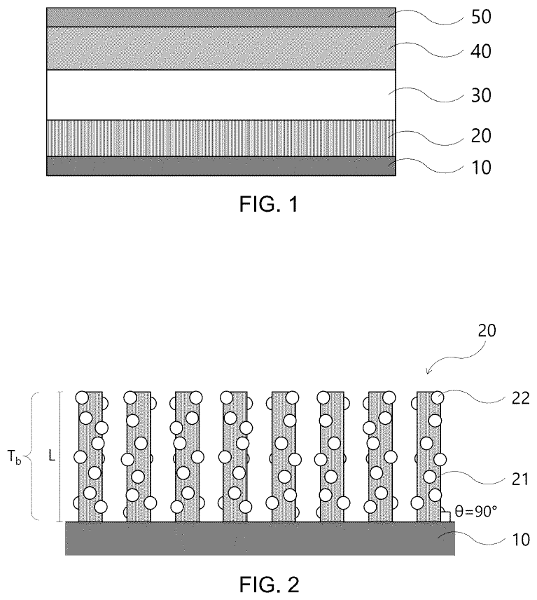

FIG. 1 is a cross-sectional view showing an all-solid-state battery according to the present disclosure, specifically an anodeless all-solid-state battery to solve the problems of the conventional all-solid-state battery. Referring to FIG. 1, an all-solid-state battery according to one embodiment of the present disclosure may include an anode current collector 10, a buffer layer 20 located on the anode current collector 10, a solid electrolyte layer 30 including a solid electrolyte and located on the buffer layer 20, a cathode active material layer 40 including a cathode active material and located on the solid electrolyte layer 30, and a cathode current collector 50 located on the cathode active material layer 40.

The anode current collector 10 may be a plate-shaped substrate having electrical conductivity. Specifically, the anode current collector 10 may have the form of a sheet, a thin film or foil.

The anode current collector 10 may include a material which does not react with lithium. Specifically, the anode current collector 10 may include at least one selected from the group consisting of nickel (Ni), copper (Cu), stainless steel, and combinations thereof.

The thickness of the anode current collector 10 is not particularly limited, and may be, for example, 1 μm to 500 μm.

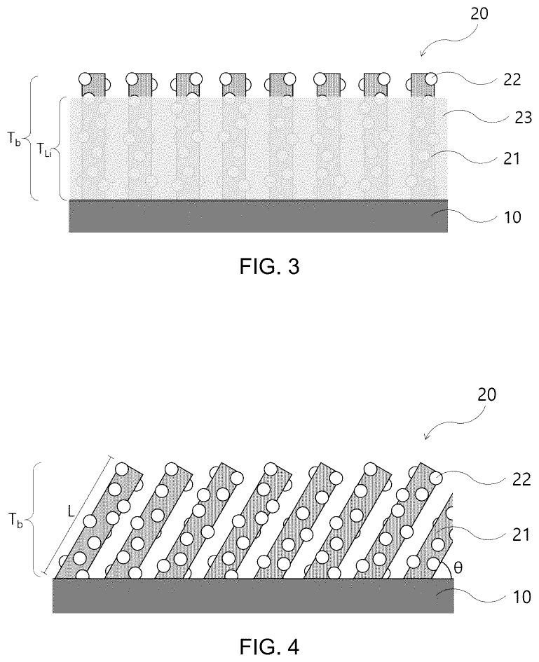

FIG. 2 is a view showing the discharged state of the buffer layer 20 according to the present disclosure, and FIG. 3 is a view showing the charged state of the buffer layer according to the present disclosure. The buffer layer 20 according to the present disclosure includes a carbon sheet including an oriented carbon material 21 aligned to form a predetermined angle θ with the anode current collector 10, and lithiophilic metal particles 22 attached to the surface of the oriented carbon material 21.

In the all-solid-state battery according to the present disclosure, lithium ions released from the cathode active material may move to the anode layer, i.e., the buffer layer 20, via the solid electrolyte layer 30. These ions may then be deposited in the form of lithium metal from the vicinities of the lithiophilic metal materials 22 (e.g. lithiophilic metal particles) are associated with (e.g. attached to or incorporated into) the oriented carbon material 21. Further, deposition of lithium metal may proceed from the lithiophilic metal particles 22 towards the anode current collector 10.

Here, the oriented carbon material 21 is aligned close to perpendicular to the anode current collector 10, as will be described later, and thus, not only volume expansion of the buffer layer 20 in the vertical direction but also volume expansion of the buffer layer 20 in the horizontal direction may be suppressed.

The oriented carbon material 21 has a designated area so that the lithiophilic metal particles 22 may be attached to the surface of the oriented carbon material 21, and the shape of the oriented carbon material 21 is not particularly limited, and may be a cylindrical or fibrous shape, as shown in FIG. 2.

For example, the oriented carbon material 21 may include at least one selected from the group consisting of carbon nanofibers, carbon nanotubes, vapor grown carbon fibers, and combinations thereof. Further, the oriented carbon material 21 may have electrical conductivity.

Preferably, the oriented carbon material 21 may include vertically aligned carbon nanotubes (VA-CNTs). The vertically aligned carbon nanotubes (VA-CNTs) may refer to carbon nanotubes oriented at an angle θ close to perpendicular to the anode current collector 10 and a bundle which is a collection thereof. Here, the term “vertically aligned carbon nanotubes” does not only refer to cases where the oriented carbon material 21 and the anode current collector 10 form an angle θ of exactly 90°, but also includes cases in which the oriented carbon material 21 is aligned close to perpendicular to the anode current collector 10 at an angle θ ranging from 60° to 90°, as shown in FIG. 4.

When the angle θ between the oriented carbon material 21 and the anode current collector 10 is less than 60°, lithium is deposited unevenly, and the volume expansion of the buffer layer 20 may not be effectively suppressed, which may easily deteriorate the performance of the all-solid-state battery.

Further, the oriented carbon material 21 may be provided such that respective oriented carbon material units or bundles of the oriented carbon material units are disposed at designated distances within the carbon sheet. As the oriented carbon material 21 is provided such that the respective units or bundles of oriented carbon material are disposed at the designated distances, the carbon sheet and the buffer layer 20, which includes the oriented carbon material, may have a porous structure.

As the carbon sheet and the buffer layer 20 including the same have the porous structure, lithium ions may be deposited in the form of lithium metal in spaces between adjacent oriented carbon material units during the charging process of the all-solid-state battery according to the present disclosure. Therefore, even if lithium metal is deposited in the buffer layer 20 during charging of the all-solid-state battery, volume change of the lithium metal may be absorbed by the porous structure.

Preferably, the porous structure of the buffer layer 20 may accommodate all volume changes due to deposition of lithium. Accordingly, the thickness Tb of the buffer layer 20 when the all-solid-state battery is in a fully charged state (SoC of 100) and the thickness Tb of the buffer layer 20 when the all-solid-state battery is in a fully discharged state (SoC of 0) may be the same or substantially the same.

In one embodiment, the porosity of the buffer layer 20 may be 50% or more. The buffer layer 20 should secure a porosity of at least 50% to accommodate all volume changes due to lithium deposition without changing the thickness of the buffer layer 20 and to allow lithium to be uniformly deposited.

The porosity of the buffer layer 20 may be measured according to, for example, the Brunauer-Emmett-Teller (BET) method, mercury (Hg) porosimetry, or ASTM D-2873.

Alternatively, the net density of the buffer layer 20 may be calculated from the density (apparent density) of the buffer layer 20, the composition ratio of materials included in the buffer layer 20 and the densities of respective components, and the porosity of the buffer layer 20 may be calculated from a difference between the apparent density and the net density of the buffer layer 20. For example, the porosity may be calculated using Equation 1 below.

$$[ Equation 1 ]$$

$$Porosity = ( volume \% ) = \{ 1 - ( Apparent density / Net density ) \} \times 100$$

In Equation 1, the apparent density may be calculated from Equation 2 below.

$$[ Equation 2 ]$$

$$Apparent density ( g / {cm}^{3} ) = ( Weight of porous buffer layer ( g ) ) \text{} / \{ ( Thickness of porous buffer layer ( cm ) ) \times ( Area of porous buffer layer ( {cm}^{2} ) )$$

FIG. 3 schematically shows the buffer layer 20 when the all-solid-state battery according to the present disclosure is fully charged. When the all-solid-state battery according to the present disclosure is charged, lithium ions released from the cathode active material may be deposited in the form of metal from the vicinities of lithiophilic metal particles 22 located on the anode current collector 10, thus forming a lithium layer 23.

Here, when the all-solid-state battery is in the fully charged state (SoC of 100), the thickness Tui of the lithium layer 23 including lithium deposited in the buffer layer 20 may be equal to or less than the thickness Tb of the buffer layer 20. Preferably, when the all-solid-state battery is in the fully charged state (SoC of 100), the thickness T_{Li} of the lithium layer 23 and the thickness Tb of the buffer layer 20 may be the same or substantially the same.

Due to the characteristics of the all-solid-state battery which is operated under a predetermined pressure applied in the stacking direction of the all-solid-state battery, when the thickness T_{Li} of the lithium layer 23 exceeds the thickness Tb of the buffer layer 20, deposition of lithium may occur up to the edge of the buffer layer 20. When the all-solid-state battery continues to be charged and discharged in the state in which lithium is deposited up to the edge of the buffer layer 20, voltage is concentrated upon the edge of the buffer layer 20, lithium deposition may be accelerated, and the electrochemical characteristics of the all-solid-state battery may be further deteriorated.

In the all-solid-state battery according to the present disclosure, the thickness T_{Li} of the lithium layer 23 including lithium deposited in the buffer layer 20 is equal to or less than the thickness Tb of the buffer layer 20, and thus, deposition of lithium up to the edge of the buffer layer 20 may be prevented. Further, when the thickness T_{Li} of the lithium layer 23 and the thickness Tb of the buffer layer 20 are the same in the fully charged state (SoC of 100) of the all-solid-state battery, excellent electrochemical performance in terms of energy density is exhibited, while both volume expansion of the buffer layer 20 in the vertical direction and volume expansion of the buffer layer 20 in the horizontal direction may be suppressed.

In one embodiment, the thickness Tb of the buffer layer 20 may be 4 to 50 μm. Here, the thickness Tb of the buffer layer 20 may be determined depending on the capacity of the all-solid-state battery including the buffer layer 20. For example, when the capacity of a single-plated cell including the buffer layer 20 is 0-1.0 mAh/cm², the thickness Tb of the buffer layer 20 may be 4-10 μm. When the capacity of the single-plated cell is 1.0-3.0 mAh/cm², the thickness Tb of the buffer layer 20 may be 12-30 μm. When the capacity of the single-plated cell is 3.0-5.0 mAh/cm², the thickness Tb of the buffer layer 20 may be 20-50 μm.

When the thickness Tb of the buffer layer 20 is less than 4 μm, the buffer layer 20 may not sufficiently accommodate volume changes due to lithium deposition, and it may be difficult to suppress volume expansion in the horizontal direction. When the thickness Tb of the buffer layer 20 exceeds 50 μm, the energy density of the all-solid-state battery may be reduced.

When the angle θ formed by the oriented carbon material 21 and the anode current collector 10 is 90°, the length L of the oriented carbon material 21 and the thickness Tb of the buffer layer 20 may be the same or substantially the same. When the angle θ formed by the oriented carbon material 21 and the anode current collector 10 is equal to or greater than 60° but less than 90°, the length L of the oriented carbon material 21 and the thickness Tb of the buffer layer 20 may be different.

In one embodiment, the length L of the oriented carbon material 21 may be 4 to 60 μm. When the length L of the oriented carbon material 21 is less than 4 μm, the buffer layer 20 may not sufficiently accommodate volume change due to lithium deposition, and it may be difficult to suppress volume expansion of the buffer layer 20 in the horizontal direction. When the length L of the oriented carbon material 21 exceeds 60 μm, the energy density of the all-solid-state battery may be reduced.

Further, in one embodiment, the lithiophilic metal particles 22 includes one selected from the group consisting of silver (Ag), gold (Au), magnesium (Mg), aluminum (Al), indium (In), silicon (Si), manganese (Mn), tin (Sn), bismuth (Bi), zinc (Zn), germanium (Ge), platinum (Pt), antimony (Sb), and combinations thereof.

The lithiophilic metal particles 22 may refer to a metal element in the form of particles which may easily form an alloy with lithium to induce lithium ions. Preferably, the lithiophilic metal particles 22 may include silver (Ag).

The lithiophilic metal particles 22 may vary depending on the temperature and time required to stir the carbon sheet including the oriented carbon material 21, as will be described later. However, preferably, the lithiophilic metal particles 22 may not form a separate layer on the surface of the oriented carbon material 21. When the lithiophilic metal particles 22 are attached to the surface of the oriented carbon material 21 to form a layer having a predetermined thickness, the porosity of the buffer layer 20 may be reduced. Consequently, it may be difficult to provide spaces sufficient to accommodate lithium metal deposited in the buffer layer 20.

In one embodiment, the weight ratio of the lithiophilic metal particles 22 to the carbon sheet of the buffer layer 20 may be 1:5 to 1:15.

When the weight ratio of the lithiophilic metal particles 22 to the carbon sheet of the buffer layer 20 is less than 1:5, the ratio of the lithiophilic metal particles 22 in the buffer layer 20 may be excessively high. Specifically, the lithiophilic metal particles 22 may form a separate layer having a predetermined thickness on the surface of the oriented carbon material 21 and thus it may be difficult to provide spaces sufficient to accommodate lithium metal deposited in the buffer layer 20. Further, the energy density of the all-solid-state battery may be reduced.

When the weight ratio of the lithiophilic metal particles 22 to the carbon sheet exceeds 1:15, the ratio of the lithiophilic metal particles 22 in the buffer layer 20 may be excessively small. Specifically, as the lithiophilic metal particles 22 in the buffer layer 20 do not sufficiently induce lithium ions, lithium metal may be deposited at the interface between the buffer layer 20 and the solid electrolyte layer 30. In this case, when charging and discharging of the all-solid-state battery is repeated, the growth of lithium dendrites may be accelerated.

The solid electrolyte layer 30 may be located between the cathode active material layer 40 and the buffer layer 20, and may include a solid electrolyte having lithium-ion conductivity.

The solid electrolyte may include one selected from the group consisting of an oxide-based solid electrolyte, a sulfide-based solid electrolyte, and a polymer electrolyte, and combinations thereof. However, a sulfide-based solid electrolyte having high lithium-ion conductivity may preferably be used as the solid electrolyte.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like, without being particularly limited.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The polymer electrolyte may include a gel polymer electrolyte, a solid polymer electrolyte, or the like.

The solid electrolyte layer 30 may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

The cathode active material layer 40 reversibly intercalates and deintercalates lithium ions may include a cathode active material, a conductive material, a binder, and the like. In addition, a solid electrolyte may be mixed with the cathode active material layer 40.

The cathode active material may be an oxide active material or a sulfide active material.

The oxide active material may be a rocksalt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rocksalt layer-type active material in which a part of a transition metal is substituted with a different kind of metal, such as LiNi_{0.8}CO_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M is at least one of Al, Mg, Co, Fe, Ni or Zn, and 0<x+y<2), or lithium titanate, such as Li₄Ti₅O₁₂.

The sulfide active material may be copper Chevrel, iron sulfide, cobalt sulfide, nickel sulfide, or the like.

The solid electrolyte mixed with the cathode active material layer 40 may be substantially the same as the solid electrolyte included in the solid electrolyte layer 30. The conductive material may be carbon black, conductive graphite, ethylene black, carbon fiber, graphene, or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

The cathode current collector 50 may be a plate-shaped substrate having electrical conductivity. Specifically, the cathode current collector 50 may have the form of a sheet or a thin film. The cathode current collector 50 may include at least one selected from the group consisting of indium (In), copper (Cu), magnesium (Mg), aluminum (Al), stainless steel, iron (Fe), and combinations thereof. Specifically, the cathode current collector 50 may include aluminum foil.

The thickness of the cathode current collector 50 is not particularly limited, and may be, for example, 1 μm to 500 μm.

Hereinafter, a manufacturing method of an all-solid-state battery according to the present disclosure will be described.

Manufacturing Method of all-Solid-State Battery

The manufacturing method of the all-solid-state battery according to the present disclosure may include immersing a carbon sheet including an oriented carbon material 21 into a solution including a salt of lithiophilic metal particles 22 and a reducing agent, forming a buffer layer 20 by attaching the lithiophilic metal particles 22 to the surface of the oriented carbon material 21 by stirring the solution into which the carbon sheet is put, and sequentially stacking an anode current collector 10, the buffer layer 20, a solid electrolyte layer 30 including a solid electrolyte, a cathode active material layer 40 including a cathode active material, and a cathode current collector 50.

Hereinafter, the respective operations will be described in more detail.

First, the carbon sheet including the oriented carbon material 21 may be put into the solution including the reducing agent and the salt of the lithiophilic metal particles 22.

The salt generally refers to a compound in which cations and anions are combined by electrical attraction, and in this specification, the salt of the lithiophilic metal particles 22 may refer to, when the lithiophilic metal particles 22 exist in the form of cations in the solution, a compound including anions combined with the cations by electrical attraction. For example, when the lithiophilic metal particles 22 are silver (Ag) particles, the salt of silver (Ag) may be silver nitrate (AgNO₃).

In one embodiment, the reducing agent may be any compound that serves to reduce the lithiophilic metal particles 22 existing in the form of the cations in the solution, without being particularly limited. For example, the reducing agent may include trisodium citrate.

The carbon sheet incudes the oriented carbon material 21 and is substantially the same as that of the above-described “all-solid-state battery”, and a detailed description thereof will thus be omitted.

After immersing the carbon sheet into the solution, the lithiophilic metal particles 22 in the form of the cations may be reduced by stirring the solution. The reduced lithiophilic metal particles 22 may be dispersed in a colloidal state, including nanoparticles, in the solution.

An equation for the reduction reaction occurring during the process of stirring the solution is as follows.

mMeⁿ⁺+nRed→mMe⁰+n0ₓ [Reduction Reaction Equation]

(Here, Me being the Lithiophilic Metal and Red being the Reducing Agent)

For example, when trisodium citrate is used as the reducing agent and silver (Ag) is used as the lithiophilic metal particles 22, the following reaction may occur during the stirring process.

4Ag⁺+Na₃C₆H₅O₇+2H₂O→4Ag⁰+C₆H₈O₇+3Na⁺+H⁺+O₂ [Reduction Equation]

Here, stirring the solution may be performed at a temperature of 70° C. to 90° C. When the temperature at which the solution is stirred is lower than 70° C., the reaction may not occur or reduction of silver (Ag) may not be completely performed. When the temperature at which the solution is stirred is higher than 90° C., as the reaction temperature increases, the leaching rate of silver (Ag) increases, and it may be difficult to obtain the size or amount of metal particles desired to be obtained by the present disclosure.

Preferably, stirring the solution may be performed at a temperature of 75° C. to 80° C. When stirring the solution is performed in the above temperature range, metal nanoparticles of a more appropriate amount and size may be reduced on the surface of the oriented carbon material 21.

Further, stirring the solution may be performed for 30 to 60 minutes. When the stirring time is less than 30 minutes, reduction of lithium metal particles may not sufficiently occur. Even when the stirring time exceeds 60 minutes, the leaching rate is similar, and thus process efficiency may be reduced.

When stirring is continued after forming a colloid dispersed in the solution, the lithiophilic metal particles 22 may attach to the surface of the oriented carbon material 21. The buffer layer 20 may then be formed by taking the carbon sheet, with the lithiophilic metal particles 22 attached to the surface of the oriented carbon material 21, out of the solution.

At this time, the buffer layer 20 may be formed more efficiently by additionally performing a drying process. In the drying process, a solvent remaining on the surface of the carbon sheet or the buffer layer 20 is evaporated, and the drying temperature or time is not particularly limited and may be adjusted to a level sufficient to evaporate the solvent.

After forming the buffer layer 20 via the stirring process and/or the drying process, the all-solid-state battery may be manufactured by sequentially stacking the anode current collector 10, the buffer layer 20, the solid electrolyte layer 30 including the solid electrolyte, the cathode active material layer 40 including the cathode active material, and the cathode current collector 50. Here, the anode current collector 10, the solid electrolyte layer 30, the cathode active material layer 40, and the cathode current collector 50 are substantially the same as those of the above-described “all-solid-state battery”, and the process of manufacturing the all-solid-state battery by stacking the respective elements may use a stacking method which is commonly used in the art.

The all-solid-state battery manufactured according to the manufacturing method of the preset disclosure may be substantially the same as the above-described all-solid-state battery. For example, the lithiophilic metal particles 22 used in the manufacturing method according to the present disclosure may include one selected from the group consisting of silver (Ag), gold (Au), magnesium (Mg), aluminum (Al), indium (In), silicon (Si), manganese (Mn), tin (Sn), bismuth (Bi), zinc (Zn), germanium (Ge), platinum (Pt), antimony (Sb), and combinations thereof.

The oriented carbon material 21 used in the manufacturing method according to the present disclosure may include vertically aligned carbon nanotubes (VA-CNTs).

The length L of the oriented carbon material 21 used in the manufacturing method according to the present disclosure may be 4 to 60 μm.

The angle θ formed by the oriented carbon material 21 and the anode current collector 10 used in the manufacturing method according to the present disclosure may be 60° to 90°.

The thickness Tb of the buffer layer 20 in the manufacturing method according to the present disclosure may be 4 to 50 μm.

The buffer layer 20 in the manufacturing method according to the present disclosure may have a porous structure, and the porosity of the buffer layer 20 may be 50% or more.

The weight ratio of the lithiophilic metal particles 22 to the carbon sheet of the buffer layer 20 in the manufacturing method according to the present disclosure may be 1:5 to 1:15.

When the all-solid-state battery manufactured by the manufacturing method according to the present disclosure is in the fully charged state (SoC of 100), the thickness T_{Li} of a lithium layer 23 including lithium deposited in the buffer layer 20 may be equal to or less than the thickness Tb of the buffer layer 20.

The thickness Tb of the buffer layer 20 when the all-solid-state battery manufactured by the manufacturing method according to the present disclosure is in the fully charged state (SoC of 100) and the thickness Tb of the buffer layer 20 when the all-solid-state battery is the fully discharged state (SoC of 0) may be the same or substantially the same.

The lithiophilic metal particles 22 of the all-solid-state battery manufactured by the manufacturing method according to the present disclosure may not form a separate layer.

Hereinafter, the present disclosure will be described in more detail through the following Examples and Comparative Examples. The following Examples and Comparative Examples serve merely to exemplarily describe the present disclosure, and are not intended to limit the scope and spirit of the disclosure.

### Example 1—VA-CNTs+Ag

(1) A solution was prepared by putting trisodium citrate prepared as a reducing agent and AgNO₃, which is a salt of lithiophilic metal particles, into DI water as a solvent. A carbon sheet including vertically aligned carbon nanotubes (VA-CNTs, NAWA TECHNOLOGIES) was put into the solution.
(2) The carbon sheet with silver (Ag) particles attached to the surfaces of the vertically aligned carbon nanotubes (VA-CNTs) by stirring the solution into which the vertically aligned carbon nanotubes (VA-CNTs) was put at a temperature of 80° C. and about 300 rpm for 40 minutes. A buffer layer was manufactured by taking the carbon sheet out of the solution and drying the carbon sheet to remove the remaining solution.
(3) Thereafter, an all-solid-state battery was assembled by sequentially stacking a nickel thin film, the buffer layer, a solid electrolyte layer including an argyrodite-type sulfide-based solid electrolyte and existing in the form of a free-standing film without a separate support, a cathode active material layer including NCM 811-based cathode active material, and an aluminum thin film. The all-solid-state battery was set as Example 1.

Here, specific conditions for the carbon sheet and the lithiophilic metal particles used to form the buffer layer in the process of assembling the all-solid-state battery according to Example 1 are set forth in Table 1.

TABLE 1

| Weight | | | Density of mixture | Loading | | Ag usage per |
|---|---|---|---|---|---|---|
| Before | After | Increased | before pressing | amount | Ag:carbon | reference capacity |
| synthesis (mg) | synthesis (mg) | weight(mg) | (g/cc) | (mg/cm²) | (wt %) | (mAh/cm²) |
| 19.6 | 21.4 | 1.8 | 0.02 | 0.06 | 1:10.9 | 21.07 |

### Comparative Example 1—AgC

A composite layer in which silver (Ag) particles were dispersed on graphite (C) was manufactured without separately synthesizing a buffer layer. Thereafter, an all-solid-state battery was assembled by sequentially stacking a nickel thin film, the composite layer, a solid electrolyte layer including an argyrodite-type sulfide-based solid electrolyte and existing in the form of a free-standing film without a separate support, a cathode active material layer including NCM 811-based cathode active material, and an aluminum thin film. The all-solid-state battery was set as Comparative Example 1.

### Comparative Example 2—VA-CNTs

An all-solid-state battery was assembled through the same process as in Example 1 except that a carbon sheet including vertically aligned carbon nanotubes (VA-CNTs) without silver (Ag), serving as lithiophilic metal particles, attached to the surfaces thereof was used as a buffer layer. The all-solid-state battery was set as Comparative Example 2.

### Comparative Example—CNTs+Ag

An all-solid-state battery was assembled through the same process as in Example 1 except that a carbon sheet including carbon nanotubes (CNTs) having a network structure was used rather than an oriented carbon material in which carbon materials were aligned in one direction. The all-solid-state battery was set as Comparative Example 3.

### Test Example 1—Voltage Characteristic Analysis Depending on Initial Charging and Discharging

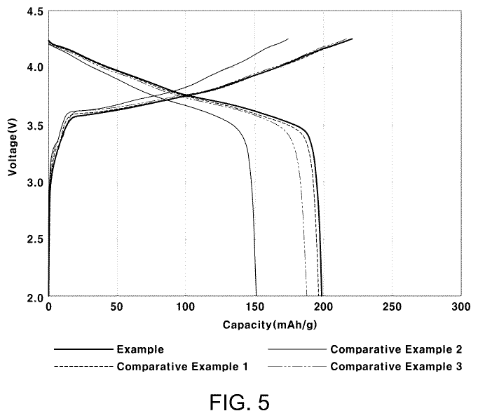

In order to determine electrochemical characteristics of the all-solid-state batteries according to Example and Comparative Examples, initial charging and discharging was performed at a rate of 0.33 C and a cut-off voltage of 2 V to 4.25 V. Results of such a test are shown in FIG. 5 and Table 2 below.

TABLE 2

| | Charging | Discharging | | |
|---|---|---|---|---|
| | (mAh/g) | (mAh/g) | Efficiency (%) | DC-IR(Ω) |
| Example 1 | 220.3 | 199.3 | 90.4 | 1.74 |
| Comp. example 1 | 219.1 | 195.8 | 89.3 | 5.4 |
| Comp. example 2 | 173.9 | 150.9 | 86.8 | 11.4 |
| Comp. example 3 | 201.4 | 180.8 | 90.2 | 6.3 |

Referring to FIG. 5 and Table 2, it may be confirmed that the all-solid-state battery according to Example 1, in which the buffer layer including the carbon sheet including the vertically aligned carbon nanotubes and silver (Ag) particles attached to the surface of the carbon sheet was provided, showed the best charge capacity, discharge capacity, and efficiency, respectively. Further, it may be confirmed that the all-solid-state battery according to Example 1 showed the lowest resistance in an internal resistance evaluation using direct current.

### Test Example 2—Durability Characteristic Analysis by Repeating Charge/Discharge Cycle

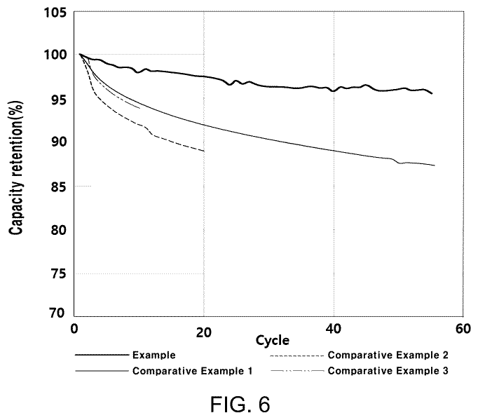

In order to confirm durability characteristics of the all-solid-state batteries according to Example and Comparative Examples, charging and discharging was performed about 57 times under the same charge and discharge conditions as in Experimental Example 1. Results of such a test are shown in FIG. 6, and capacity retentions and coulombic efficiencies of the all-solid-state batteries when charging and discharging was performed 10 times are set forth in Table 3 below.

TABLE 3

| | Capacity Retention (%) | Coulombic Efficiency (%) |
|---|---|---|
| Example 1 | 97.99 | 99.8 |
| Comp. example 1 | 94.5 | 99.2 |
| Comp. example 2 | 91.99 | 99.6 |
| Comp. example 3 | 93.9 | 98.9 |

Referring to FIG. 6, the all-solid-state batteries according to Example 1 and Comparative Example 1 only had a partial decrease in battery performance but did not make the charge-discharge test impossible due to internal short circuit during about 57 charge/discharge cycles, the all-solid-state battery according to Comparative Example 2 made the charge-discharge test impossible due to internal short circuit at about 20 cycles, and the all-solid-state battery according to Comparative Example 3 made the charge-discharge test impossible at about 10 cycles. Referring to this, it may be confirmed that the durabilities of the all-solid-state batteries according to Example 1 and Comparative Example 1 were superior to those of the all-solid-state batteries according to Comparative Examples 2 and 3.

Further, referring to Table 3 regarding results when the charge/discharge cycle was repeated 10 times, the capacity retentions and coulombic efficiencies of the all-solid-state batteries according to Example 1 and Comparative Example 1 were superior to those of the all-solid-state batteries according to Comparative Examples 2 and 3, and particularly, the all-solid-state battery according to Example 1 manufactured by the manufacturing method according to the present disclosure exhibited better capacity retention and coulombic efficiency than the all-solid-state battery according to Comparative Example 1.

Summarizing the results of Test Example 1 and Test Example 2, the all-solid-state battery according to Example 1, i.e., according to the present disclosure, exhibited the best durability. This is expected to be due to the fact that there is no volume expansion in the vertical and horizontal directions during the charge/discharge behavior, and thus, there is no structural collapse even when the charge/discharge cycle is repeated.

In addition, in the case of the all-solid-state battery according to Comparative Example 2, it is assumed that battery performance was deteriorated due to an imbalance in movement and deposition of lithium because there was no silver, which is lithiophilic metal particles.

Moreover, in the case of the all-solid-state battery using the carbon sheet without orientation according to Comparative Example 3, it is assumed that durability of the battery was reduced because the volume expansion of the battery in the vertical direction may be alleviated, but the volume expansion of the battery in the horizontal direction may not be alleviated.

As is apparent from the above description, a buffer layer according to the present disclosure includes a carbon sheet including an oriented carbon material aligned at a predetermined angle with an anode current collector, and lithiophilic metal particles attached to the surface of the oriented carbon material, thereby allowing lithium to be deposited from the vicinities of the lithiophilic metal particles during charging of an all-solid-state battery.

Accordingly, during the charging process of the all-solid-state battery, both the volume expansion in the vertical direction and the volume expansion in the horizontal direction may be suppressed at the same time. Therefore, it is possible to prevent deterioration of electrochemical characteristics of the all-solid-state battery due to changes in the volume of an anode layer occurring as the charging and discharging process is repeated.

The effects of the present disclosure are not limited to the above-mentioned effects. The effects of the present disclosure should be understood to include all effects that may be inferred from the above description.

Although the embodiments of the present disclosure have been described above, those skilled in the art will be able to modify or change the present disclosure in various ways through addition, change, deletion of components without departing from the spirit of the present disclosure as set forth in the appended claims, and this will also be included in the scope of the present disclosure.

What is claimed is:

1. An all-solid-state battery comprising:
an anode current collector;
a buffer layer located on the anode current collector;
a solid electrolyte layer comprising a solid electrolyte and located on the buffer layer;
a cathode active material layer comprising a cathode active material and located on the solid electrolyte layer; and
a cathode current collector located on the cathode active material layer,
wherein the buffer layer comprises:
a carbon sheet comprising an oriented carbon material aligned to form a predetermined angle with the anode current collector; and
lithiophilic metal material are associated with the oriented carbon material.

2. The all-solid-state battery of claim 1, wherein the oriented carbon material comprises vertically aligned carbon nanotubes (VA-CNTs).

3. The all-solid-state battery of claim 1, wherein a length of the oriented carbon material is about 4 to about 60 μm.

4. The all-solid-state battery of claim 1, wherein the predetermined angle is about 60° to about 90°.

5. The all-solid-state battery of claim 1, wherein the lithiophilic metal material comprise one selected from the group consisting of silver (Ag), gold (Au), magnesium (Mg), aluminum (Al), indium (In), silicon (Si), manganese (Mn), tin (Sn), bismuth (Bi), zinc (Zn), germanium (Ge), platinum (Pt), antimony (Sb), and combinations thereof.

6. The all-solid-state battery of claim 1, wherein a thickness of the buffer layer is about 4 to about 50 μm.

7. The all-solid-state battery of claim 1, wherein the buffer layer has a porous structure; and porosity of the buffer layer is about 50% or more.

8. The all-solid-state battery of claim 1, wherein a weight ratio of the lithiophilic metal particles to the carbon sheet of the buffer layer is about 1:5 to about 1:15.

9. The all-solid-state battery of claim 1, wherein, when the all-solid-state battery is in a fully charged state (SoC of 100), a thickness of a lithium layer comprising lithium deposited in the buffer layer is equal to or less than a thickness of the buffer layer.

10. The all-solid-state battery of claim 1, wherein a thickness of the buffer layer when the all-solid-state battery is in a fully charged state (SoC of 100) and a thickness of the buffer layer when the all-solid-state battery is in a fully discharged state (SoC of 0) are the same or substantially the same.

11. The all-solid-state battery of claim 1, wherein the lithiophilic metal material do not form a separate layer.

12. A manufacturing method of an all-solid-state battery comprising:
immersing a carbon sheet comprising an oriented carbon material into a solution comprising a salt of lithiophilic metal material and a reducing agent;
stirring the solution with the carbon sheet to attach the lithiophilic metal material to a surface of the oriented carbon material, thereby forming a buffer layer; and
stacking an anode current collector; the buffer layer; a solid electrolyte layer comprising a solid electrolyte; a cathode active material layer comprising a cathode active material; and a cathode current collector.

13. The manufacturing method of claim 12, wherein stirring the solution is performed at a temperature of about 70° C. to about 90° C.

14. The manufacturing method of claim 12, wherein the reducing agent comprises trisodium citrate.

15. The manufacturing method of claim 12, wherein the oriented carbon material comprises vertically aligned carbon nanotubes (VA-CNTs).

16. The manufacturing method of claim 12, wherein a length of the oriented carbon material is about 4 to about 60 μm.

17. The manufacturing method of claim 12, wherein an angle formed by the oriented carbon material and the anode current collector is about 60° to about 90°.

18. The manufacturing method of claim 12, wherein the lithiophilic metal material comprise one selected from the group consisting of silver (Ag), gold (Au), magnesium (Mg), aluminum (Al), indium (In), silicon (Si), manganese (Mn), tin (Sn), bismuth (Bi), zinc (Zn), germanium (Ge), platinum (Pt), antimony (Sb), and combinations thereof.

19. The manufacturing method of claim 12, wherein a thickness of the buffer layer is about 4 to about 50 μm.

20. A vehicle comprising an all-solid-state battery of claim 1.
